(19) United States
(12) Patent Application Publication
(10) Pub. No.: US 2008/0030347 A1
(43) Pub. Date: Feb. 7, 2008

(54) Thermometer having warning device

(76) Inventor: Cheng Yi Hsu, Changhua (TW)

Correspondence Address: CHARLES E. BAXLEY, ESQ., 90 JOHN STREET, THIRD FLOOR, NEW YORK, NY, 10038, US

(21) Appl. No.: 11/497,965

(22) Filed: Aug. 2, 2006

(51) Int. Cl. G08B 23/00; G01J 5/00; G08B 17/00

(52) U.S. Cl. 340/573.1; 340/584; 374/121

(57) ABSTRACT

A thermometer includes a circuit board disposed in a housing, a detector attached to the circuit board for detecting a temperature signal of a user, a processor device attached to the circuit board and electrically coupled to the detector for receiving the detected temperature signal of the user from the detector, and a displayer attached to the circuit board and electrically coupled to the processor device for displaying the detected temperature signal of the user. A warning device may be attached to the circuit board and electrically coupled to the processor device for generating a warning signal when the user is detected to be over-heated for allowing the user to be taken care of as early as possible.

### BACKGROUND OF THE INVENTION

1. Field of the Invention

The present invention relates to a thermometer, and more particularly to a thermometer including a warning device for generating warning signals to indicate that the user has an over-heated temperature.

2. Description of the Prior Art

Typical thermometers comprise an elongated, transparent housing for receiving an indicating means therein and for attaching to such as the armpit or the like of the users for taking or detecting the temperature of the users.

For example, U.S. Pat. No. 3,998,098 to Chilton discloses one of the typical disposable thermometers also comprising an elongated, transparent housing for attaching to such as the armpit or the like of the users and for taking or detecting or measuring the temperature of the users.

Normally, the thermometers are required to be attached to such as the armpit of the users manually or by the nurses themselves. This is all right for the parents to take care of their children or for the nursing persons to take care of few patients.

However, in such as the hospitals, there are many patients required to be taken care of by few nurses and it may take a long time to measure the temperature of all of the patients. This is particularly inconvenient and exhausted to measure the temperature of all of the patients during the night.

The present invention has arisen to mitigate and/or obviate the afore-described disadvantages of the conventional thermometers.

### SUMMARY OF THE INVENTION

The primary objective of the present invention is to provide a thermometer including a warning device for generating warning signals to indicate that the user has an over-heated temperature for allowing the user's family or the nurses or the like to take action as early as possible or for allowing the user to be taken care of as early as possible.

In accordance with one aspect of the invention, there is provided a thermometer comprising a housing, a circuit board disposed in the housing, a detector attached to the circuit board for detecting a temperature signal of a user, a processor device attached to the circuit board and electrically coupled to the detector for receiving the detected temperature signal of the user from the detector, a displayer attached to the circuit board and electrically coupled to the processor device for displaying the detected temperature signal of the user, and a warning device attached to the circuit board and electrically coupled to the processor device for generating a warning signal when the user is detected to be over-heated and for allowing the user to be taken care of as early as possible.

The housing includes an inner peripheral shoulder formed therein for engaging with the circuit board and for stably anchoring and positioning the circuit board in the housing.

The housing includes a cover attached onto an upper portion thereof for enclosing the chamber of the housing and for retaining the circuit board in the housing. The cover includes an orifice formed therein and aligned with the warning device for allowing the warning signal to be emitted out of the housing.

The warning device may be selected from a buzzer, a light device, a vibrating device or the like.

The housing includes an adhesive member attached onto a lower portion thereof for attaching onto a user. The adhesive member includes at least one channel formed therein for air circulation purposes.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a thermometer in accordance with the present invention;

FIG. 2 is a bottom perspective view illustrating a circuit board of the thermometer;

FIG. 3 is a perspective view of the thermometer;

FIG. 4 is a cross sectional view of the thermometer taken along lines 4-4 of FIG. 3;

FIG. 5 is a plan schematic view of the thermometer;

FIG. 6 is a partial bottom schematic view of the thermometer;

FIG. 7 is a perspective view illustrating the operation of the thermometer;

FIG. 8 is an exploded view similar to FIG. 1, illustrating the other arrangement of the thermometer; and

FIG. 9 is an exploded view similar to FIGS. 1 and 8, illustrating the further arrangement of the thermometer.

### DETAILED DESCRIPTION OF THE PREFERRED EMBODIMENT

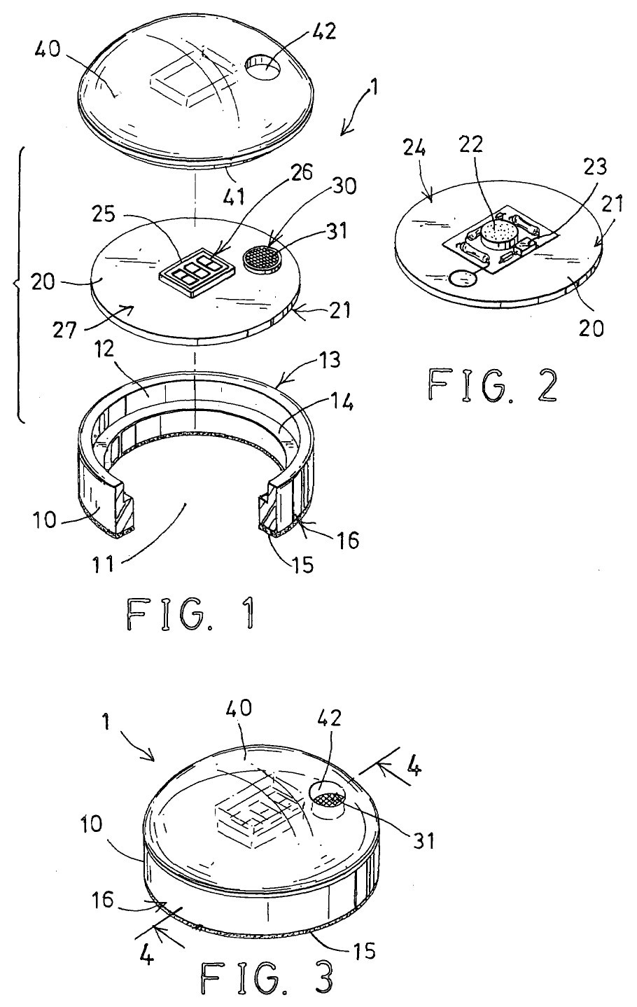

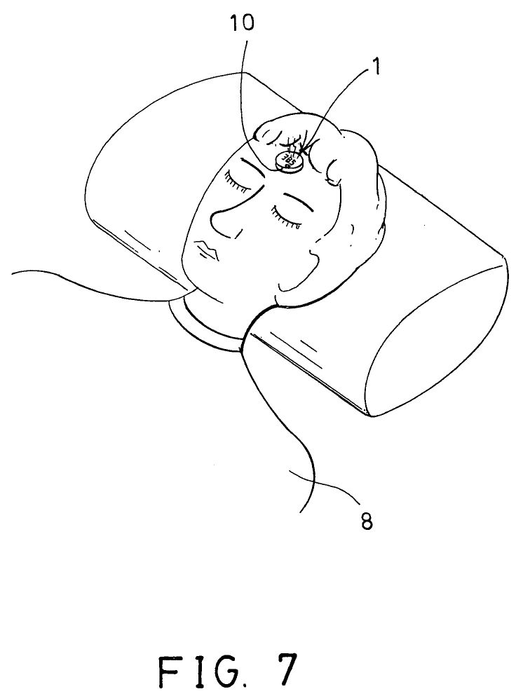

Referring to the drawings, and initially to FIGS. 1-6, a thermometer 1 in accordance with the present invention comprises a housing 10 including a circular or peripheral structure having a chamber 11 formed therein, and including an enlarged space 12 formed in the upper portion 13 thereof and having an inner diameter greater than that of the chamber 11 of the housing 10 for forming or defining an inner peripheral shoulder 14 in the housing 10, and/or located between the chamber 11 and the enlarged space 12 of the housing 10. An adhesive layer or member 15 may be attached to the lower or bottom portion 16 of the housing 10 for attaching or securing onto a user 8, such as onto the forehead of the user 8 (FIGS. 5, 7).

As shown in FIGS. 1 and 4-6, the adhesive layer or member 15 includes a bore 17 formed therein for forming or defining an circular or peripheral structure similar to that of the housing 10, and preferably includes one or more slots or channels 18 laterally formed through the adhesive layer or member 15 (FIG. 6) for air circulation purposes and for preventing the chamber 11 of the housing 10 from being completely sealed or enclosed when the housing 10 is attached or secured onto the user 8, and also for preventing the heat from being accumulated within the chamber 11 of the housing 10, and also for allowing the user 8 to feel more comfortable.

A circuit board 20 includes an outer diameter equals to or slightly smaller than that of the enlarged space 12 of the housing 10, but greater than that of the chamber 11 of the housing 10, or includes an outer peripheral portion 21 for engaging into the enlarged space 12 of the housing 10 and for engaging with the inner peripheral shoulder 14 of the housing 10, and thus for allowing the circuit board 20 to be stably anchored or positioned or retained in the housing 10. The circuit board 20 may be solidly secured in the housing 10 with such as a force-fitted engagement, or an adhesive materials, or latches or fasteners (not shown), or the like, for preventing the circuit board 20 from being moved relative to the housing 10.

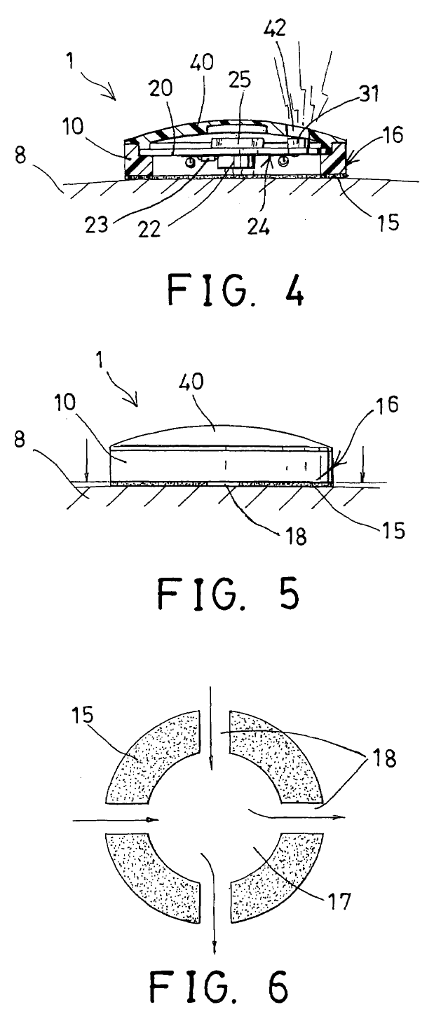

The circuit board 20 includes a probe or sensor or detector 22 and an integrated circuit or processor device 23 disposed or attached on the lower or bottom portion 24 thereof (FIGS. 2, 4) for allowing the detector 22 to be faced or disposed closer to the user 8 (FIG. 4) and for suitably detecting or measuring the temperature of the user 8. The integrated circuit or processor device 23 is electrically coupled to the detector 22 for receiving the detected signals or the detected temperatures of the user 8 from the detector 22 and for recording and/or storing and/or processing the detected signals or temperatures of the user 8.

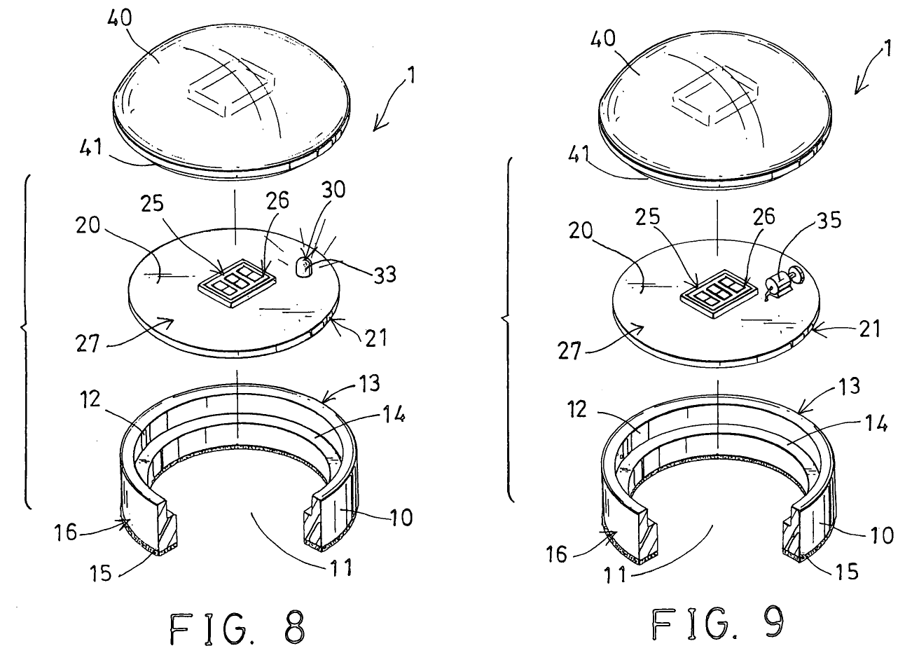

The circuit board 20 further includes a screen or displayer 25 and/or one or more flash light devices 26 disposed or attached on the upper portion 27 thereof and electrically coupled to the processor device 23 for such as displaying or showing the detected signals or temperatures of the user 8. The circuit board 20 further includes a warning device 30, such as a buzzer 31 (FIGS. 1, 3, 4), an indicating or flash light device 33 (FIG. 8), a vibrating device 35 (FIG. 9), or the like also disposed or attached onto such as the lower or bottom portion 24 or the upper portion 27 of the circuit board 20 and electrically coupled to the processor device 23 for generating a warning signal, such as a warning sound, a warning light or warning flash light, a vibration, or the like in order to warn the user when the user has an over-heated temperature, for example.

Normally, the temperature of the user under about 38° C. is still acceptable, but it will be dangerous when the temperature of the user is above about 38.5° C. Accordingly, it is preferable that the warning device 30 may be provided for generating the warning signal when the temperature of the user is above about 38.5° C. When warning device 30 generates the warning signal, such as the warning sound, the warning light or warning flash light, the vibration, or the like, the user's family or the nurses or the patient himself may take action as early as possible or for allowing the user to be taken care of as early as possible and for preventing the user from being hurt by over-heating.

A cover 40, such as a transparent or semi-transparent cover 40 may further be provided and includes an engaging member 41, such as a peripheral bulge or a threaded member for engaging with the upper portion 13 of the housing 10 and for detachably securing the cover 40 to the housing 10 and for enclosing the chamber 11 of the housing 10 and for further stably retaining the circuit board 20 in the housing 10. It is preferable that the cover 40 includes an orifice 42 formed therein and aligned with the buzzer 31 of the warning device 30, for example, for allowing the warning sound or signal to be suitably emitted out of the housing 10 and thus for allowing the warning sound or signal to be suitably heard by people.

Accordingly, the thermometer in accordance with the present invention includes a warning device for generating warning signals to indicate that the user has an over-heated temperature for allowing the user's family or the nurses or the like to take action as early as possible or for allowing the user to be taken care of as early as possible.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A thermometer comprising:
a housing,
a circuit board disposed in said housing,
a detector attached to said circuit board for detecting a temperature signal of a user,
a processor device attached to said circuit board and electrically coupled to said detector for receiving the detected temperature signal of the user from said detector,
a displayer attached to said circuit board and electrically coupled to said processor device for displaying the detected temperature signal of the user, and
a warning device attached to said circuit board and electrically coupled to said processor device for generating a warning signal when the user is detected to be over-heated.

2. The thermometer as claimed in claim 1, wherein said housing includes an inner peripheral shoulder formed therein for engaging with said circuit board and for stably anchoring and positioning said circuit board in said housing.

3. The thermometer as claimed in claim 1, wherein said housing includes a cover attached onto an upper portion thereof for enclosing said chamber of said housing and for retaining said circuit board in said housing.

4. The thermometer as claimed in claim 3, wherein said cover includes an orifice formed therein and aligned with said warning device for allowing the warning signal to be emitted out of said housing.

5. The thermometer as claimed in claim 1, wherein said warning device is a buzzer.

6. The thermometer as claimed in claim 1, wherein said warning device is a light device.

7. The thermometer as claimed in claim 1, wherein said warning device is a vibrating device.

8. The thermometer as claimed in claim 1, wherein said housing includes an adhesive member attached onto a lower portion thereof for attaching onto a user.

9. The thermometer as claimed in claim 8, wherein said adhesive member includes at least one channel formed therein for air circulation purposes.
